(19) United States
(12) Patent Application Publication
(10) Pub. No.: US 2019/0071002 A1
(43) Pub. Date: Mar. 7, 2019

(54) DYNAMIC BRAKE LIGHT SYSTEM

(71) Applicant: Cary Scott, Virginia Beach, VA (US)

(72) Inventor: Cary Scott, Virginia Beach, VA (US)

(21) Appl. No.: 16/116,608

(22) Filed: Aug. 29, 2018

Related U.S. Application Data
(60) Provisional application No. 62/554,363, filed on Sep. 5, 2017.

(51) Int. Cl. B60Q 1/44

(52) U.S. Cl. CPC B60Q 1/447

(57) ABSTRACT

A dynamic brake light system for a vehicle having a brake pedal, a communication module, and a speedometer is disclosed herein. The present invention provides a dynamic brake light configured to illuminate in accordance with the deceleration velocity of the vehicle as registered via an accelerometer or how much pressure is applied to the brake system. The dynamic brake light includes an elongated brake light installed to a rear section of the motor vehicle configured to receive input from the brake system. The dynamic brake light system is installable on any make or model of vehicle, including commercial vehicles. The dynamic brake light provides for a safer alternative to standard brake lights, enabling other motorists to adjust their braking as needed to maintain a consistent speed.

### CROSS-REFERENCE TO RELATED APPLICATION

The present application is related to and claims priority to U.S. Provisional Patent Application No. 62/554,363 filed Sep. 5, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of vehicle safety accessories and more specifically relates to vehicle brake lights.

### 2. Description of Related Art

Utilizing a vehicle's brake system is integral to driving. Other motorists on the roadway may have a difficult time identifying how quickly another vehicle is decelerating. Some vehicles may come to a sudden stop and be accidentally rear-ended due to other motorists being unaware of how fast he/she is braking. Serious injuries could occur, even during minor rear-end collisions.

Further, all vehicles have automotive lighting. The lighting system of a motor vehicle generally includes lighting and signaling devices mounted or integrated to the front, rear, sides, and in some cases the top of a motor vehicle. This allows other drivers and pedestrians to see a vehicle's presence, position, size, direction of travel, and the driver's intentions regarding direction and speed of travel.

U.S. Publication No. 2014/0309856 to Angela M. Willson-Quayle relates to a vehicle velocity visual alert system with discrete and unambiguous brake and “stopped” status features to reduce rear-end crashes. The described vehicle velocity visual alert system with discrete and unambiguous brake and “stopped” status features to reduce rear-end crashes includes a velocity-contingent rear and interior colored-lights visual alert system which signals real-time information from a lead car to following drivers via a processor-memory-speedometer-brake configuration that shows a lead vehicle's: (1) actual and changing speeds; (2) degree of brake pressure when decelerating and (3) stationary status. The main alert device has a plurality of adjacent speed indicator lights with braking and stopped status elements. A processor memory is configured to store programming and speed and brake look-up tables associating speed ranges with activation of specific colored lights and braking speed with a brake pressure alert subsystem. The processor executes programming via the interconnectedness of the speedometer, accelerator, brake, brake pressure sensor and the main device.

To promote safer driving conditions behind and minimize rear end accidents, a suitable brake light is desired.

### BRIEF SUMMARY OF THE INVENTION

In view of the foregoing disadvantages inherent in the known vehicle safety accessories art, the present disclosure provides a novel dynamic brake light system. The general purpose of the present disclosure, which will be described subsequently in greater detail, is to provide a brake light configured to illuminate in accordance with the deceleration velocity of a motor vehicle as registered via an accelerometer or how much pressure is applied to the brake system.

The dynamic brake light system may generally comprise an elongated brake light installed to a rear section of the motor vehicle. The dynamic brake light is configured to receive input from the brake system. The dynamic brake light may be installed conveniently on any make or model of vehicle, including commercial vehicles. The dynamic brake light may replace brake systems during the manufacturing process or as an after-market alternative to standard brake lights. The dynamic brake light of the present disclosure teaches a safer alternative to standard brake lights, enabling other motorists to adjust their braking as needed to maintain a consistent speed.

A dynamic brake light system for a vehicle, the vehicle having a brake pedal, a communication module, and a speedometer, is disclosed herein. The dynamic brake light system may generally include a variable brake light display consisting of a plurality of intensity settings, a deceleration determination unit configured to monitor and determine varying degrees of deceleration of the vehicle, and a controller electronically coupled to the vehicle and to the variable brake light display, and communicably coupled to the deceleration determination unit. The controller may be configured to operate the variable brake light display in the plurality of intensity settings, and responsive to a predetermined change in deceleration of the vehicle, as communicated via the deceleration determination unit.

A method of using the dynamic brake light system for the vehicle having a brake pedal, a communication module, and a speedometer is also disclosed herein. The method of using the dynamic brake light system may comprise the steps of: step one, providing the dynamic brake light system including a variable brake light display may have a plurality of intensity settings, a deceleration determination unit configured to monitor and determine varying degrees of deceleration of the vehicle, and a controller electronically coupled to the vehicle and to the variable brake light display, and communicably coupled to the deceleration determination unit, the controller configured to operate the variable brake light display in the plurality of intensity settings, and responsive to a predetermined change in deceleration of the vehicle, as communicated via the deceleration determination unit; step two, installing the variable brake light display to a back of the vehicle; step three, measuring a deceleration value via the deceleration measurement unit when the vehicle may be braking; and step four, visually-indicating a deceleration range of the vehicle via the variable brake light display.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, dynamic brake light system, constructed and operative according to the teachings of the present disclosure.

FIG. 1 is a perspective view of a dynamic brake light system for a vehicle during an ‘in-use’ condition, according to an embodiment of the disclosure.

FIG. 2 is a front view of a variable brake light display of the dynamic brake light system for a vehicle of FIG. 1, according to an embodiment of the present disclosure.

FIG. 3 is a perspective view of the variable brake light display in communication with a controller configured to control the variable brake light display, according to an embodiment of the present disclosure.

FIG. 4A is a perspective view of the dynamic brake light system for a vehicle during an ‘in-use’ condition, showing the variable brake light display emitting few lights indicating a gentle brake, according to an embodiment of the present disclosure.

FIG. 4B is a perspective view of the dynamic brake light system for a vehicle during the ‘in-use’ condition, showing the variable brake light display emitting many lights indicating a strong brake, according to an embodiment of the present disclosure.

FIG. 5 is a flow diagram illustrating a method of use for the dynamic brake light system for a vehicle according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to vehicle safety accessories and more particularly to a dynamic brake light system as used to improve the vehicle brake light art.

Generally, a dynamic brake light system may generally comprise a customized brake system comprising a vehicular deceleration detector and an elongated brake light to help improve safety on the roadways. The elongated brake light may advantageously include sequential illumination based on a measurement of the vehicle's deceleration. The light array on the brake light may include one or more colors and may increase in strength or length from the center and outward depending on the measurement of the vehicle's deceleration.

In such a manner, a motorist may apply a light amount of pressure to illuminate the center portion of the elongated brake light. As more pressure is applied, the LED light extends on both sides of the brake light system. If pressure is fully applied to the brake to stop the vehicle, the LEDs illuminate the entire elongated brake light, and may even pulsate if the measurement exceeds a maximum deceleration reading. Other motorists on the roadway may then be able to identify how much pressure is being applied to the brake depending on how much of the elongated brake light is illuminated.

A computational system may also be equipped within the brake system designed to decipher the pressure/speed ratio to determine how much the light should be illuminated. This may particularly be useful in “stop-and-go” situations in traffic where drivers may apply light pressure to the brake, but not further illuminate the brake light. The system may be configured to illuminate the light in a manner to extend the full length of the bar, signifying a full stop.

The dynamic brake light system may be constructed using plastic and other suitable materials. The system may be connected directly to a vehicle's interior wiring, thereby accommodating virtually any make or model of vehicle. The system may be manufactured directly into a vehicle or installed as an after-market accessory.

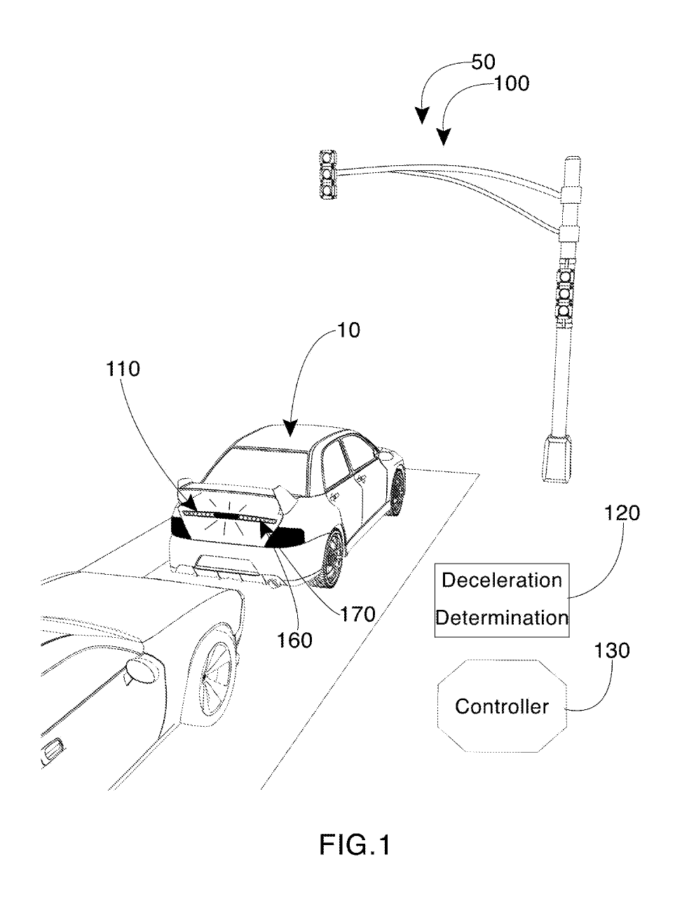

Referring now more specifically to the drawings by numerals of reference, there is shown in FIGS. 1-4B, various views of a dynamic brake light system 100 for a vehicle 10, the vehicle 10 having a brake pedal, a communication module, and a speedometer. Specifically, FIG. 1 illustrates a perspective show of the dynamic brake light system 100 for a vehicle 10, the dynamic brake light system 100 comprising a variable brake light display 110, a deceleration determination unit 120, a controller 130, a plurality of intensity settings 160, and a plurality of lights 170.

Referring now to FIG. 1 showing the dynamic brake light system 100 for a vehicle 10 during an ‘in-use’ condition 50 by a user 40, according to an embodiment of the present disclosure. As illustrated, the dynamic brake light system 100 may include a variable brake light display 110 having a plurality of intensity settings 160; a deceleration determination unit 120 configured to monitor and determine varying degrees of deceleration of the vehicle 10; and a controller 130 electronically coupled to the vehicle 10 and to the variable brake light display 110, and communicably coupled to the deceleration determination unit 120, the controller 130 configured to operate the variable brake light display 110 in the plurality of intensity settings 160, and responsive to a predetermined change in deceleration of the vehicle 10, as communicated via the deceleration determination unit 120.

In continuing to refer to FIG. 1 the deceleration determination unit 120 may include a brake pedal sensor 410 configured to sense and communicate varying degrees of pressure applied to the brake pedal of the vehicle 10 to the controller 130. In another embodiment of the present invention, the deceleration determination unit 120 may include an accelerometer 420 configured to sense and communicate deceleration of the vehicle 10 to the controller 130. In yet another embodiment of the present invention, the deceleration determination unit 120 may be configured to determine deceleration of the vehicle 10 via one or more components of the speedometer of the vehicle 10 to the controller 130.

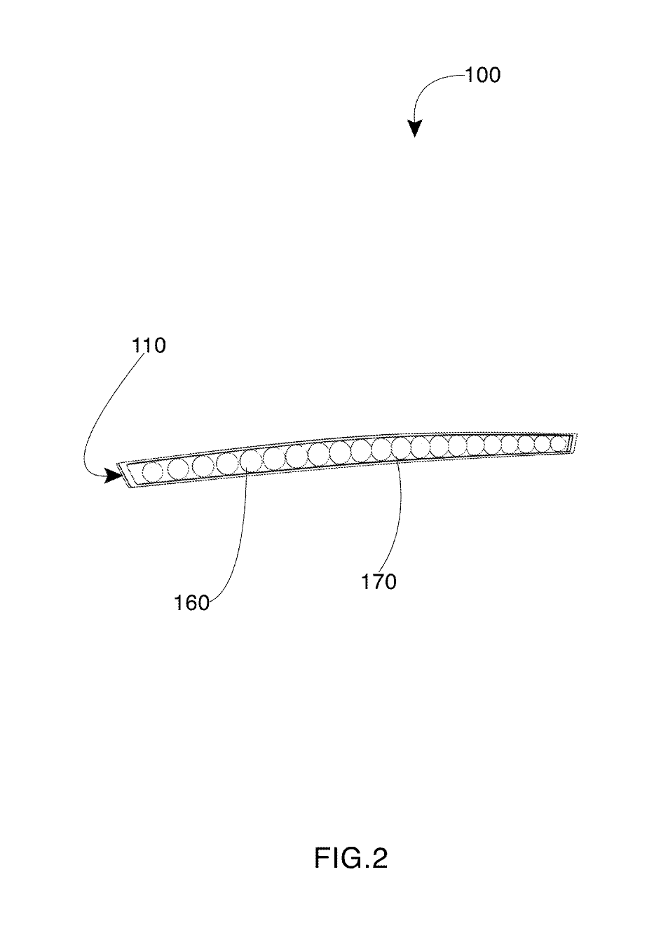

Referring now to FIG. 2 showing a front view of the dynamic brake light 100 for a vehicle 10 of FIG. 1, according to an embodiment of the present disclosure. The dynamic brake light 100 for a vehicle 10 may comprise a variable brake light display 110, a deceleration determination unit 120, a controller 130, intensity settings 160, and a plurality of lights 170.

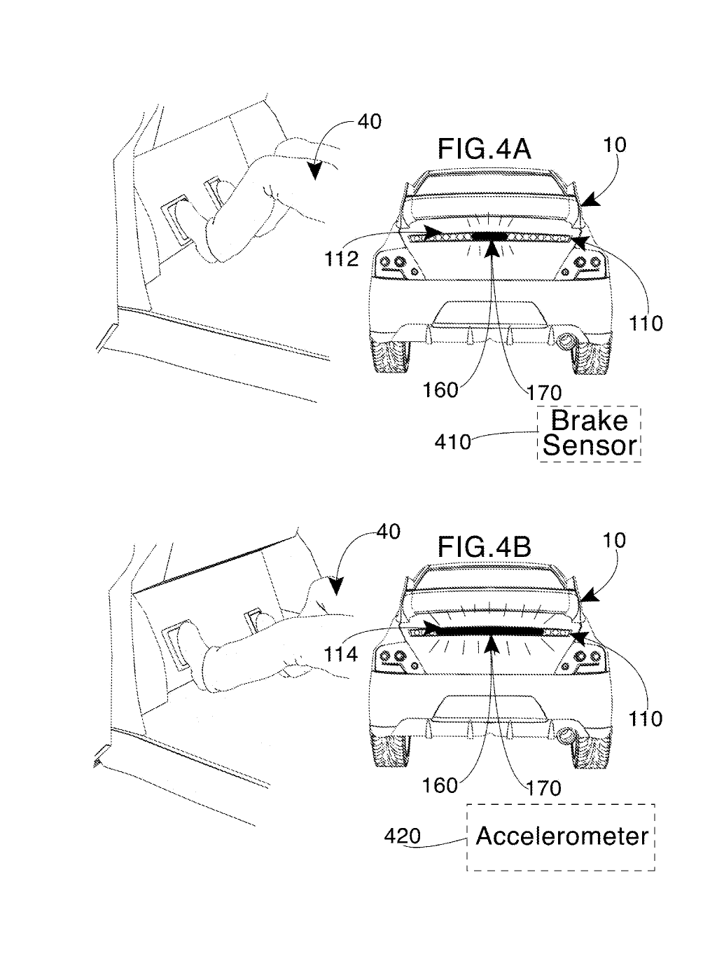

The variable brake light display 110 may generally comprise a housing having a plurality of lights 170. The housing may be mounted to a rear of a vehicle 10 in an area where typical brake lights are installed. The plurality of lights 170 may include at least a first subset of lights 112 and a second subset of lights 114 (as shown best in FIGS. 4A and 4B). As may be appreciated, the plurality of lights 170 may comprise light emitting diode (LED) lights. Other lights may be utilized as known in the art.

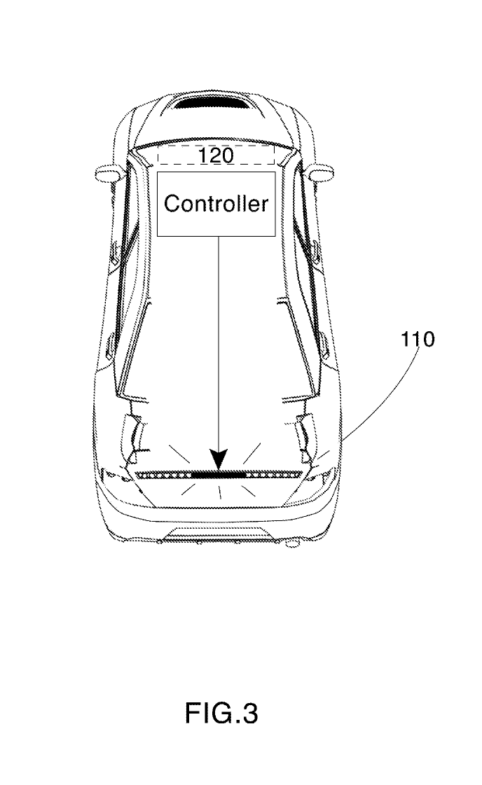

Referring now to FIG. 3 showing a perspective view of the variable brake light display 110 in communication with the controller 130 configured to control the variable brake light display 110, according to an embodiment of the present disclosure.

In one embodiment of the present invention, the plurality of intensity settings 160 may include a setting configured to activate the first subset of lights 112. Further, the plurality of intensity settings 160 may include another setting configured to activate the second subset of lights 114. Additionally, the plurality of intensity settings 160 may further include another setting configured to activate the first subset of lights 112 and the second subset of lights 114 concurrently. The controller 130 may be programmed to control the first subset of lights 112 and the second subset of lights 114 of the plurality of lights 170 in response to deceleration of the vehicle 10.

Referring now to FIG. 4A showing a perspective view of the dynamic brake light system 100 for a vehicle 10 during an ‘in-use’ condition 50, showing the variable brake light display 110 emitting few lights equal to the first subset of lights 112 indicating a gentle brake, according to an embodiment of the present disclosure.

Referring now to FIG. 4B showing a perspective view of the dynamic brake light system 100 for a vehicle 10 during an ‘in-use’ condition 50, showing the variable brake light display 110 emitting many lights equal to the second subset of lights 114 indicating a strong brake, according to an embodiment of the present disclosure.

In referring to FIGS. 4A and 4B, the plurality of intensity settings 160 may include a setting configured to activate the first subset of lights 112. Further, the plurality of intensity settings 160 may include another setting configured to activate the second subset of lights 114. Additionally, the plurality of intensity settings 160 may further include another setting configured to activate the first subset of lights 112 and the second subset of lights 114 concurrently.

In one embodiment of the present invention, the plurality of intensity settings 160 includes a setting for increasing a brightness level of the plurality of lights 170. Further, the plurality of intensity settings 160 may include a pulse setting whereby the plurality of lights 170 are configured to pulsate when the pulsating setting is activated.

Preferably, the plurality of lights 170 may be divided into at least three subsets of lights, including a first subset of lights 112, a second subset of lights 114, and a third subset of lights; and wherein the varying degrees of deceleration of the vehicle 10 include a first deceleration range and a second deceleration range.

In still referring to FIGS. 4A and 4B, the variable brake light display 110 has a center region that includes the first subset of lights 112. Here, the controller 130 is configured to operate the first subset of lights 112 of the variable brake light display 110 in isolation when the deceleration of the vehicle 10 is within the first deceleration range.

In continuing to refer to FIGS. 4A and 4B, the variable brake light display 110 may also comprise a left region and a right region that together include the second subset of lights 114. The left region and the right region may flank opposite sides of the center region and may be positioned adjacent to the center region. Preferably, the left region and the right region have equal lengths measured as extending from said center region. The controller 130 may be configured to operate the first subset of lights 112 and the second subset of lights 114 of the variable brake light display 110 concurrently when the deceleration of the vehicle 10 is within the second deceleration range. In one version, the first deceleration range is less than the second deceleration range. In another version, the first deceleration range is greater than the second deceleration range.

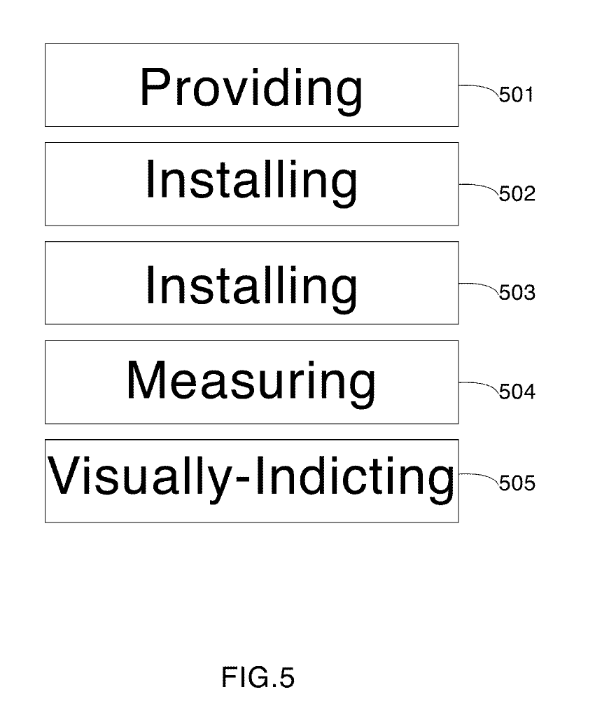

FIG. 5 is a flow diagram 550 illustrating a method 500 of communicating varying degrees of deceleration of a vehicle 10, the vehicle 10 having a vehicle control system, a brake pedal, a communication bus, and a speedometer, the method 500 comprising the steps of: step one 501, providing a visual brake light for use with a vehicle having a computer processor, the visual brake light including a variable brake light display may have a plurality of intensity settings, a deceleration determination unit configured to monitor and determine varying degrees of deceleration of the vehicle, and a controller electronically coupled to the vehicle and in communication with the computer processor of the vehicle and to the variable brake light display, and communicably coupled to the deceleration determination unit, the controller configured to operate the variable brake light display in the plurality of intensity settings, and responsive to a predetermined change in deceleration of the vehicle, as communicated via the deceleration determination unit; step two 502, installing the variable brake light display to a back of the vehicle; step three 503, measuring a deceleration value via the deceleration measurement unit when the vehicle may be braking; and step four 504, visually-indicating a deceleration range of the vehicle via the variable brake light display.

It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for the dynamic brake light for a vehicle 100 (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A dynamic brake light for a vehicle, the vehicle having a brake pedal, a communication module, and a speedometer, the dynamic brake light comprising:
a variable brake light display having a plurality of intensity settings;
a deceleration determination unit configured to monitor and determine varying degrees of deceleration of the vehicle; and
a controller electronically coupled to the vehicle and to the variable brake light display, and communicably coupled to the deceleration determination unit, the controller configured to operate the variable brake light display in the plurality of intensity settings, and responsive to a predetermined change in deceleration of the vehicle, as communicated via the deceleration determination unit.

2. The dynamic brake light of claim 1, wherein the deceleration determination unit includes a brake pedal sensor configured to sense and communicate varying degrees of pressure applied to the brake pedal of the vehicle to the controller.

3. The dynamic brake light of claim 1, wherein the deceleration determination unit includes an accelerometer configured to sense and communicate deceleration of the vehicle to the controller.

4. The dynamic brake light of claim 1, wherein the deceleration determination unit is configured to determine deceleration of the vehicle via one or more components of the speedometer of the vehicle to the controller.

5. The dynamic brake light of claim 1, wherein the variable brake light display includes a plurality of lights.

6. The dynamic brake light of claim 5, wherein the plurality of lights includes at least a first subset of lights and a second subset of lights.

7. The dynamic brake light of claim 6, wherein the plurality of intensity settings includes a setting configured to activate the first subset of lights.

8. The dynamic brake light of claim 7, wherein the plurality of intensity settings further includes another setting configured to activate the second subset of lights.

9. The dynamic brake light of claim 7, wherein the plurality of intensity settings further includes another setting configured to activate the first subset of lights and the second subset of lights concurrently.

10. The dynamic brake light of claim 5, wherein the plurality of intensity settings includes a setting for increasing a brightness level of the plurality of lights.

11. The dynamic brake light of claim 5, wherein the plurality of intensity settings includes a pulse setting whereby the plurality of lights are configured to pulsate when the pulsating setting is activated.

12. The dynamic brake light of claim 5, wherein the plurality of lights are divided into at least three subsets of lights, including a first subset of lights, a second subset of lights, and a third subset of lights; and
wherein the varying degrees of deceleration of the vehicle include a first deceleration range and a second deceleration range.

13. The dynamic brake light of claim 12, wherein the variable brake light display has a center region that includes the first subset of lights; and
wherein the controller is further configured to operate the first subset of lights of the variable brake light display in isolation when the deceleration of the vehicle is within the first deceleration range.

14. The dynamic brake light of claim 13, wherein the variable brake light display also has a left region and a right region that together include the second subset of lights, said left region and said right region flanking opposite sides of the center region and being positioned adjacent to said center region, the left region and the right region having equal lengths measured as extending from said center region; and
wherein the controller is further configured to operate the first subset of lights and the second subset of lights of the variable brake light display concurrently when the deceleration of the vehicle is within the second deceleration range.

15. The dynamic brake light of claim 14, wherein the first deceleration range is less than the second deceleration range.

16. The dynamic brake light of claim 14, wherein the first deceleration range is greater than the second deceleration range.

17. The dynamic brake light of claim 5, wherein the plurality of lights are light emitting diode (LED) lights.

18. A dynamic brake light, the dynamic brake light comprising:
a variable brake light display comprising a plurality of lights and having a plurality of intensity settings, the plurality of lights including at least two subset of lights, the plurality of intensity settings including a setting configured to activate at least one subset of lights;
a deceleration determination unit configured to monitor and determine varying degrees of deceleration of the vehicle; and
a controller electronically coupled to the vehicle and to the variable brake light display, and communicably coupled to the deceleration determination unit, the controller configured to operate the variable brake light display in the plurality of intensity settings, and responsive to a predetermined change in deceleration of the vehicle, as communicated via the deceleration determination unit.

19. The dynamic brake light of claim 18, wherein the deceleration determination unit comprises a brake pedal sensor configured to sense and communicate varying degrees of pressure applied to the brake pedal of the vehicle to the controller and alternatively an accelerometer.

20. A method of communicating varying degrees of deceleration of a vehicle, the vehicle having a vehicle control system, a brake pedal, a communication bus, and a speedometer, the method comprising the steps of:
providing a visual brake light including
a variable brake light display having a plurality of intensity settings,
a deceleration determination unit configured to monitor and determine varying degrees of deceleration of the vehicle, and
a controller electronically coupled to the vehicle and to the variable brake light display, and communicably coupled to the deceleration determination unit, the controller configured to operate the variable brake light display in the plurality of intensity settings, and responsive to a predetermined change in deceleration of the vehicle, as communicated via the deceleration determination unit;
installing the variable brake light display to a back of the vehicle;
measuring a deceleration value via the deceleration measurement unit when the vehicle is braking; and
visually-indicating a deceleration range of the vehicle via the variable brake light display.
